(19) United States
(12) Patent Application Publication
(10) Pub. No.: US 2011/0090702 A1
(43) Pub. Date: Apr. 21, 2011

(54) LIGHT PEN

(75) Inventors: HUNG-LUNG HO, Tu-Cheng (TW); HO-CHIANG LIU, Tu-Cheng (TW)

(73) Assignee: HON HAI PRECISION INDUSTRY CO., LTD., Tu-Cheng (TW)

(21) Appl. No.: 12/788,286

(22) Filed: May 26, 2010

(30) Foreign Application Priority Data
Oct. 20, 2009 (CN) 200910308511.9

(51) Int. Cl. G02B 1/08; F21V 5/04

(52) U.S. Cl. 362/311.02; 250/504 H

(57) ABSTRACT

A light pen with an open end includes a light emitting diode and a light shielding element. The light-emitting diode is fixed in the light pen, and includes a light guide body facing the open end. The light shielding element is made of opaque material and disposed between the open end and the light-emitting diode. The light shielding element defines a through hole configured for allowing light at a half-intensity angle of the light-emitting diode to pass therethrough.

### BACKGROUND

1. Technical Field

The present disclosure relates to input devices for computers and, particularly, to a light pen.

2. Description of Related Art

With the development of computers, there are more and more light pens used as input devices for computers. Infrared light-emitting diodes (LED) are used as light sources for light pens. The LED includes a base, with a light generating element and a light guide body both mounted on the base. The light guide body extends along the emitting direction of the light generating element. The half-intensity angle of the LED is determined by the light guide body. The LED projects two light spots on an object, a smaller spot formed in the range of the half-intensity angle, and a larger spot formed surrounding the smaller spot. A photosensor in the computer should detect the position of the smaller spot on a screen of the computer to determine the position of the light pen on the screen. However, sometimes the photosensor may not be able to distinguish between the two spots and detect the exact position of the light pen on the screen.

What is needed, therefore, is a light pen to overcome the above-described problem.

### BRIEF DESCRIPTION OF THE DRAWINGS

Many aspects of the light pen can be better understood with reference to the following drawings. The components in the drawings are not necessarily drawn to scale, the emphasis instead being placed upon clearly illustrating the principles of the light pen.

FIG. 1 is a cross-sectional view of a light pen according to a first exemplary embodiment.

FIG. 2 is a cross-sectional view of a light pen according to a second exemplary embodiment.

### DETAILED DESCRIPTION

Embodiments of the present disclosure will now be described in detail below, with reference to the accompanying drawings.

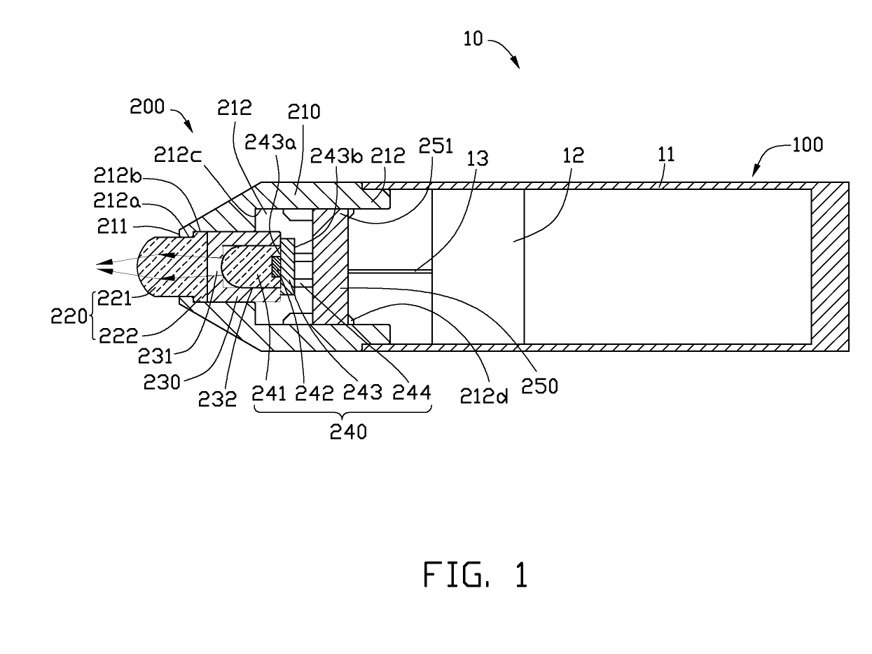

Referring to FIG. 1, a light pen 10 according to a first exemplary embodiment, is shown. The light pen 10 includes a pen shaft 100 and a pen tip 200 formed at an end of the pen shaft 100.

The pen tip 200 includes a tip casing 210, a lens 220, a light shielding element 230, an LED 240, and a circuit board 250. The tip casing 210 includes a first open end 211 and a second open end 212 opposite to the first open end 211. The tip casing 210 defines a first hole 212a, a second hole 212b, and a third hole 212c arranged in an order from the first open end 211 to the second open end 212. The second hole 212b has a diameter smaller than that of the third hole 212c but larger than that of the first hole 212a. Two sliding slots 212d are formed on the inner surface of the third hole 212c. The circuit board 250 is received in the third hole 212c with two opposite edges 251 of the circuit board 250 being received in the corresponding sliding slots 212d.

The LED 240 is fixed on the circuit board 250. In the present embodiment, the LED 240 is an infrared light-emitting diode. The LED 240 includes a light guide body 241, a light generating element 242, a base 243, and two pins 244. The base 243 includes a first surface 243a and a second surface 243b opposite to the first surface 243a. The light generating element 242 is fixed on the first surface 243a. The light guide body 241 is disposed on the first surface 243a for covering the light generating element 242. The two pins 244 are fixed on the second surface 243b to electrically couple the light generating element 242 to the circuit board 250.

The light shielding element 230 is made of opaque material. In the present embodiment, the light shielding element 230 is a tube made of black plastic. The light shielding element 230 is received in the second hole 212b and sleeved on the light guide body 241 to shield the light out of the half-intensity angle of the LED 240. An end of the light shielding element 230 resists on the lens 220. The light shielding element 230 defines a through hole 231. The through hole 231 allows the light at the half-intensity angle of the LED 240 to pass therethrough. With the light shielding element 230, the light pen 10 projects a bright spot formed in the range of the half-intensity angle of the LED 240. The light shielding element 230 limits the axial position of LED 240. The through hole 231 is formed at an end of the light shield element 230, opposite to the LED 240. In the present embodiment, the through hole 231 is coaxial to the second hole 212b, and the light shielding element 230 keeps the LED 240 coaxial to the second hole 212b. The through hole 231 is a round hole. In an alternative embodiment, the light shielding element 230 can be disk-shaped.

The lens 220 is received in the first hole 212a, and extended out of the first open end 211. The lens 220 includes an optical portion 221 and a fixing portion 222 surrounding the optical portion 221. The fixing portion 222 resists on a step formed between the first hole 212a and the second hole 212b. The optical portion 221 is extended out of the first open end 211.

The pen shaft 100 includes a shaft casing 11 and a power supply 12 received in the shaft casing 11. The power supply 12 is electrically coupled to the circuit board 250 via a wire 13. The power supply 12 supplies power to the LED 240. The light pen 10 with the light shielding element 230 only projects one bright spot formed in the range of the half-intensity angle, and shields the light from outside of the range of the half-intensity angle. Thus, positioning of the light pen 10 can be more precisely and reliably detected on a screen.

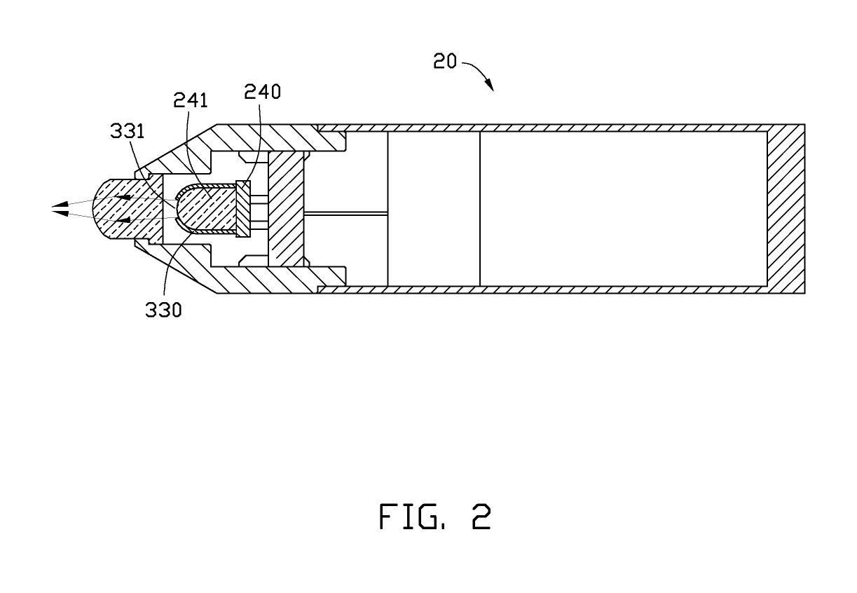

Referring to FIG. 2, a light pen 20, according to a second exemplary embodiment, is shown. The light pen 20 of the second embodiment is similar to the light pen 10 of the first embodiment, except that the light shielding element 330 is a light shielding coating covering the light guide body 241 of the LED 240. A through hole 331 is formed on the light shielding element 330 to allow the light at the half-intensity angle of the LED 240 to pass therethrough.

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

What is claimed is:

1. A light pen with an open end comprising:
a light-emitting diode fixed in the light pen, and the light-emitting diode comprising a light guide body facing the open end;
a light shielding element made of opaque material, and disposed between the open end and the light-emitting diode, the light shielding element defining a through hole configured for allowing the light at the half-intensity angle of the light-emitting diode to pass therethrough.

2. The light pen as claimed in claim 1, wherein the light shielding element is made of black plastic.

3. The light pen as claimed in claim 1, wherein the light shielding element is a tube and sleeved on the light guide body.

4. The light pen as claimed in claim 1, wherein the light shielding element is a light shielding coating covering the light guide body.

5. The light pen as claimed in claim 1, wherein the through hole is a round hole.

6. The light pen as claimed in claim 1, wherein the light pen comprises a shaft casing and a tip casing formed at a end of the shaft casing, the open end is formed on the tip casing away from the shaft casing, the light-emitting diode and the light shielding element are received in the tip casing.

7. The light pen as claimed in claim 1, wherein the light pen further comprises a lens fixed in the light pen and extended out of the open end.

8. The light pen as claimed in claim 6, wherein a power supply is received in the shaft casing, and configured for supplying power to the light emitting diode.

9. The light pen as claimed in claim 8, further comprises a circuit board fixed in the tip casing, and connecting the light emitting diode to the power supply.

10. The light pen as claimed in claim 9, wherein two sliding slots are formed on the inner surface of the tip casing, two opposite edges of the circuit board are received in the corresponding sliding slots.

11. The light pen as claimed in claim 1, wherein the light emitting diode is an infrared light-emitting diode.

12. A light pen, comprising:
a light generating member; and
a light shielding member in front of the light generating member, defining a through hole such that half-intensity light emitted by the light generating member can pass through.

13. The light pen as claimed in claim 12, further comprising a lens, wherein the light shielding member is disposed between the lens and the light generating member, and the light passing through the light shielding member further passes through the lens.

14. The light pen as claimed in claim 12, wherein the light generating member comprises a light guide body, and the light shielding member is a tube sleeved on the light guide body.

15. The light pen as claimed in claim 12, wherein the light generating member comprises a light guide body, and the light shielding member is a light shielding coating covering the light guide body.

16. The light pen as claimed in claim 13, further comprising a tip casing defining a stepped through hole, wherein the lens is fixed on one stepped surface of the stepped hole, and the light generating member is fixed on another stepped surface of the stepped hole.
